(19) United States
(12) Patent Application Publication
(10) Pub. No.: US 2017/0305032 A1
(43) Pub. Date: Oct. 26, 2017

(54) DEBARKING APPARATUS WITH LEFT AND RIGHT SIDE DEBRIS DISCHARGE

(71) Applicant: TEREX USA, LLC, Westport, CT (US)

(72) Inventor: Anders RAGNARSSON, Chester, NH (US)

(21) Appl. No.: 15/516,806

(22) PCT Filed: Oct. 5, 2015
(86) PCT No.: PCT/US15/54031

§ 371 Date: Apr. 4, 2017

Related U.S. Application Data
(60) Provisional application No. 62/060,257, filed on Oct. 6, 2014.

(51) Int. Cl. B27L 1/12; B27L 11/02; B27L 11/00

(52) U.S. Cl. CPC B27L 1/122; B27L 11/002; B27L 11/02

(57) ABSTRACT

A plunger assembly for mounting adjacent to a vertical opening of a debarking chain flail apparatus. The plunger assembly comprises first and second opposed mounting members which are securable to an undersurface thereof, and each one of mounting members defines a generally C-shaped recess. First and second plunger rails are interconnected via a plunger body, and the plunger body comprising opposed left side and right side plunging side surfaces. The first plunger rail is captively received within and guided by the first mounting frame while the second plunger rail is captively received within and guided by the second mounting frame. A first hydraulic cylinder interconnects the first mounting frame with the first plunger rail while a second hydraulic cylinder interconnects the second mounting frame with the second plunger rail to facilitate plunging in two opposed directions. The mounting frame may be mounted to the apparatus by a pair of plunger cradle and associated cradle hydraulic cylinders.

### CROSS REFERENCE TO RELATED APPLICATIONS

This application claims the benefit of a provisional application filed on Oct. 6, 2014, and having Ser. No. 62/060,257, which is hereby incorporated herein in its entirety by this reference.

### FIELD OF THE INVENTION

The present invention relates to a chain flail debarking apparatus with a plunger assembly which facilitates both left side discharge and right side discharge of dislodged bark, limbs, leaves, branches and/or other debris from a chain flail debarking apparatus.

### BACKGROUND OF THE INVENTION

Chain flails have been used for many years in forestry equipment for removing bark from tree logs and tree trunks. Such systems have been particularly useful in removing bark from logs or trunks that are subsequently cut into chips for use in the making of wood pulp products.

Wood chip manufacturers are particularly conscious of the need to remove as much bark as possible to minimize the amount of bark which is contained in the pulp chips in order to obtain the highest prices possible from the wood pulp manufacturer. If a load of wood chips contains too high a percentage of chips containing bark, then a considerably lower price is paid for such a load of wood chips.

A conventional prior art chain flail debarking apparatus 10 which is well known to be suitable for removing limbs and bark from a tree log, trunk or slab that contains bark on an exterior surface thereof, is diagrammatically illustrated in FIGS. 1 and 2. The chain flail debarking apparatus 10, typically has two or more flail assemblies 12, 14, 16 and 18 which are located within a flail section 20 so as to enable the log(s), slab(s) or trunk(s) to pass therethrough. Each of the flail assemblies 12, 14, 16 and 18 supports a plurality of chain. flails 22 (which are well known in the art and for ease of understanding the drawings are merely shown graphically by a circular path that would be taken by end points of each chain flail when rotated without encountering a tree log, trunk or slab) for engaging, pounding and abrading against the exterior surface of the log(s), slab(s) or trunk(s) to cut, dislodge and/or remove as much limbs and bark as possible as the log(s), slab(s) or trunk(s) passes through the flail section 20.

As is well known in the art, each of the flail assemblies 12, 14, 16 and 18 typically includes a horizontal arranged shaft 24 that is operatively connected to a conventional drive apparatus (not shown) for supplying rotational drive thereto. It should be understood that vertically oriented shafts with a 90 degree shift in rotation could be used as well for flail assemblies. As the flail assemblies 12, 14, 16 and 18 rotate, the chain flails 22 are directed outwardly in a substantial radial direction, via centrifugal force. As the log(s), slab(s) or trunk(s) is passed through the flail section 20, the chain flails 22 engage, pound and abrade against the exterior surface of the log(s), slab(s) or trunk(s) and cut, dislodge and/or remove limbs and bark therefrom.

As is conventional in the art, a plurality of spaced apart transfer rollers, are located within the flail section 20 to assist with conveying of the log(s), slab(s) or trunk(s), to be debarked, through the flail section 20. Debarked log(s), slab(s) or trunk(s) eventually exit the flail section 20 and are subsequently transferred, via a conventional conveyor belt or some other conventional transfer mechanism, from the discharge outlet of the flail section 20 onto a conveyor belt or some other conventional transfer mechanism (not shown). The conveyor belt or other conventional transfer mechanism conveys the debarked log(s), slab(s) or trunk(s) to an inlet of a drum or a disk chipper for supplying the debarked log(s), slab(s) or trunk(s) thereto. The chipping apparatus then chips the debarked log(s), slab(s) or trunk(s), in a conventional manner, and discharges the generated wood chips into an inlet of a discharge chute. The wood chips are then conveyed along the length of the discharge chute to an outlet thereof where the wood chips are finally discharged and either collected in a storage pile or a storage container of some sort before the wood chips are subsequently processed, e.g., by a pulp mill and/or some other consumer of debarked and/or chipped wood.

As is conventional in the art, a vertically lower most portion of the flail section 20 of the chain flail debarking apparatus 10 comprises a generally rectangular vertical opening (not shown) which permits the dislodged bark, limbs, leaves, branches and/or other debris to fall, due to gravity, into a debris collection box 32 permanently secured to the bottom portion 34 of the flail section 20 of the chain flail debarking apparatus 10. A bottom surface 36, the two sidewalls 38,42 and rear wall (not shown) of the debris collection box 32 are closed while the top surface of the debris collection box is open so as to facilitate receiving the dislodged bark, limbs, leaves, branches and/or other debris from the flail section 20. The fourth sidewall the debris collection box is also open and forms a horizontal discharge opening 44 which facilitates discharging the dislodged bark, limbs, leaves, branches and/or other debris from the debris collection box 32. The debris collection box 32 includes a conventional hydraulically operated plunger 46, which is normally located in a retracted position adjacent the rear sidewall of the debris collection box opposite the opening.

Once a sufficient amount of dislodged bark, limbs, leaves, branches and/or other debris collects within the debris collection box 32, the plunger 46 is cycled into an extended position in order to push and/or force the collected bark, limbs, leaves, branches and/or other debris out through the discharge opening 44 of the debris collection box 32. Thereafter, the plunger 46 is retracted and automatically returns back to its normally retracted position for further cycle once a sufficient amount of dislodged bark, limbs, leaves, branches and/or other debris collects within the debris collection box 32. This pushing process of the plunger 46 is repeated numerous times during operation of the chain flail debarking apparatus 10, e.g., once every 5 seconds to a few minutes or so.

One of the drawbacks associated with the prior art chain flail debarking apparatuses is that they normally include a debris collection box. It is to be appreciated that the incorporation of a debris collection box lowers the ground clearance of the chain flail debarking apparatus. Due to such lower ground clearance, the debris collecting box is somewhat prone to be dented or otherwise damaged while transporting the chain flail debarking apparatus along a logging road and/or over uneven terrain in a forest or some in some other wood harvesting area. In addition, one or more surfaces of the debris collection box tend to wear, overtime, due to repeated back and forth cycling of the plunger. Over the course of time, the debris collection box may have to be replaced or repaired, due to excessive wear or damage thereto.

### SUMMARY OF THE INVENTION

Wherefore, it is an object of the present invention to overcome the above-mentioned shortcomings and drawbacks associated with the debris collection boxes of the prior art chain flail debarking apparatuses.

Another object of the present invention is to eliminate use of a debris collection box while still provide a debris collection area, located vertically below a vertical opening provided in the flailing discharge section, which has an increased collection volume and capacity, thereby reducing the frequency that the plunger system must be cycled, automatically by the control panel or periodically by the operator, in order to remove the accumulated bark, limbs, leaves, branches and/or other debris from the debris collection area.

A further object of the present invention is to provide a plunger which can operate in either of two opposed plunging directions so that the accumulated bark, limbs, leaves, branches and/or other debris collects, which collects within the debris collection area, can be discharged toward either the right side or the left side of the chain flail debarking apparatus, thereby improving the utility and versatility of the chain flail debarking apparatus.

Yet another object of the present invention is to provide an improved, unobstructed access to an internal chamber of the flail section of the chain flail debarking apparatus, from the debris collection area and the vertical opening provided in the bottom surface of the chain flail debarking apparatus, so as to permit easy access to the internal chamber of the chain flail debarking apparatus, by an operator or service personnel, and thereby facilitate inspection and/or servicing of components contained within the internal chamber of the flail section.

A still further object of the present invention is to increase the ground clearance of the chain flail debarking apparatus, by elimination of a debris collection box and thereby improve travel and/or transportation of the chain flail debarking apparatus along a logging road or some other uneven or irregular terrain in a forest or in some other wood harvesting area.

The present invention also relates to plunger assembly for mounting adjacent to a vertical opening of a debarking chain flail apparatus, the plunger assembly comprising: first and second opposed mounting frames which are securable to an undersurface of the chain flail debarking apparatus, and each one of mounting frames defining a generally C-shaped recess; first and second opposed plunger rails being interconnected together with one another via a plunger body, the plunger body comprising opposed left side and right side plunging side surfaces, and the first plunger rail being captively received within and guided by the generally C-shaped recess of the first mounting frame, while the second plunger rail being captively received within and guided by the generally C-shaped recess of the second mounting frame; and a first hydraulic cylinder interconnecting the first mounting frame with the first plunger rail while a second hydraulic cylinder interconnecting the second mounting frame with the second plunger rail so as to facilitate a plunging motion of the plunger body in two opposed directions to facilitate discharge of debris into directions.

### BRIEF DESCRIPTION OF THE DRAWINGS

The accompanying drawings, which are incorporated in and constitute a part of the specification, illustrate various embodiments of the invention and together with the general description of the invention given above and the detailed description of the drawings given below, serve to explain the principles of the invention. It is to be appreciated that the accompanying drawings are not necessarily to scale since the emphasis is instead placed on illustrating the principles of the invention. The invention will now be described, by way of example, with reference to the accompanying drawings in which:

FIG. 1 is a diagrammatic side elevational view of a prior art chain flail debarking apparatus having a debris collection box;

FIG. 2 is a diagrammatic top plan view of the prior art chain flail debarking apparatus shown in. FIG. 1;

FIG. 3 is a diagrammatic side elevational view of a chain flail debarking apparatus, according to the present invention, incorporating the improved debris collection area and plunger arrangement;

FIG. 3A is a diagrammatic cross sectional view of the chain flail debarking apparatus, incorporating the improved debris collection area and plunger arrangement, along section line 3A-3A of FIG. 3;

FIG. 3B is a diagrammatic cross sectional view of the chain flail debarking apparatus, incorporating the improved debris collection area and plunger arrangement;

FIG. 3C is a diagrammatic cross-sectional view of the chain flail debarking apparatus of FIG. 3, showing a variant of the incorporating of the improved debris collection area and plunger arrangement;

FIG. 4 is a diagrammatic perspective view showing the improved debris collection area and plunger arrangement, according to the present invention, in a disassembled state;

FIG. 5 is a diagrammatic side elevational view of one of the plunger arms of the plunger body;

FIG. 5A is a partial diagrammatic cross-sectional view showing the plunger rail being supported by the mounting;

FIG. 6 is a diagrammatic side elevational view of one of the mounting frames supporting a hydraulic cylinder;

FIG. 7 is a diagrammatic perspective view showing mounting of the adjustable cylinder mount to one of the plunger arms;

FIG. 8 is a diagrammatic side elevational view showing the first and second mounting positions of the adjustable cylinder mount;

FIG. 9 is a diagrammatic top plan view showing the first and the second mounting positions of the adjustable cylinder mount of FIG. 8;

FIG. 10 is a diagrammatic perspective view showing of an end plunging position which facilitates discharge of the debris toward the left side of the chain flail debarking apparatus when the adjustable cylinder mounts are mounted in the first position;

FIG. 11 is a diagrammatic perspective view showing of an intermediate plunging position which facilitates discharge of the debris toward the left side of the chain flail debarking apparatus when the adjustable cylinder mounts are mounted in the first position;

FIG. 12 is a diagrammatic perspective view showing of an initial plunging position which facilitates discharge of the debris toward the left side of the chain flail debarking apparatus when the adjustable cylinder mounts are mounted in the first position;

FIG. 13 is a diagrammatic perspective view showing of an end plunging position which facilitates discharge of the debris toward the right side of the chain flail debarking apparatus when the adjustable cylinder mounts are mounted in the second position;

FIG. 14 is a diagrammatic perspective view showing of an intermediate plunging position which facilitates discharge of the debris toward the right side of the chain flail debarking apparatus when the adjustable cylinder mounts are mounted in the second position;

FIG. 15 is a diagrammatic perspective view showing of an initial plunging position which facilitates discharge of the debris toward the right side of the chain flail debarking apparatus when the adjustable cylinder mounts are mounted in the second position;

FIG. 16 is a diagrammatic side elevational view of a chain flail debarking apparatus, according to the present invention, incorporating the improved debris collection area and plunger arrangement along with a disc chipper;

FIG. 17 is a diagrammatic top plan view of FIG. 16;

FIG. 18 is a diagrammatic side elevational view of a chain flail debarking apparatus, according to the present invention, incorporating the improved debris collection area and plunger arrangement along with a disc chipper;

FIG. 19 is a diagrammatic top plan view of FIG. 18, with the discharge chute eliminated to show the features of the debris transfer chute;

FIG. 20 is a diagrammatic partial perspective view of a second embodiment of the plunger arrangement according to the present invention;

FIG. 21 is a partial bottom plan view of the second embodiment showing the initial plunging position of the plunger body for a right side plunge;

FIG. 21A is a side elevational sectional view of FIG. 21;

FIG. 21B is a left side cross-sectional view along section line 21A-21A of FIG. 21;

FIG. 22 is a partial bottom plan view of the second embodiment showing the end plunging position of the plunger body following a right side plunge of debris;

FIG. 22A is a side elevational sectional view of FIG. 22;

FIG. 22B is a left side cross-sectional view along section line 22A-22A of FIG. 22;

FIG. 23 is a partial bottom plan view of the second embodiment showing the initial plunging position of the plunger body for a left side plunge;

FIG. 23A is a side elevational sectional view of FIG. 23;

FIG. 23B is a left side cross-sectional view along section line 2.3A-23A of FIG. 21;

FIG. 24 is a partial bottom plan view of the second embodiment showing the end plunging position of the plunger body following a left side plunge of debris;

FIG. 24A is a side elevational sectional view of FIG. 24;

FIG. 24B is a left side cross-sectional view along section line 24A-24A of FIG. 24.

### DETAILED DESCRIPTION OF THE MULTIPLE EMBODIMENTS

The present invention will be understood by reference to the drawings and to the following detailed description, wherein like numbers refer to like matter throughout. It is to be appreciated that the following detailed description of various embodiments is by way of example only and is not meant to limit, in any way, the scope of the present invention.

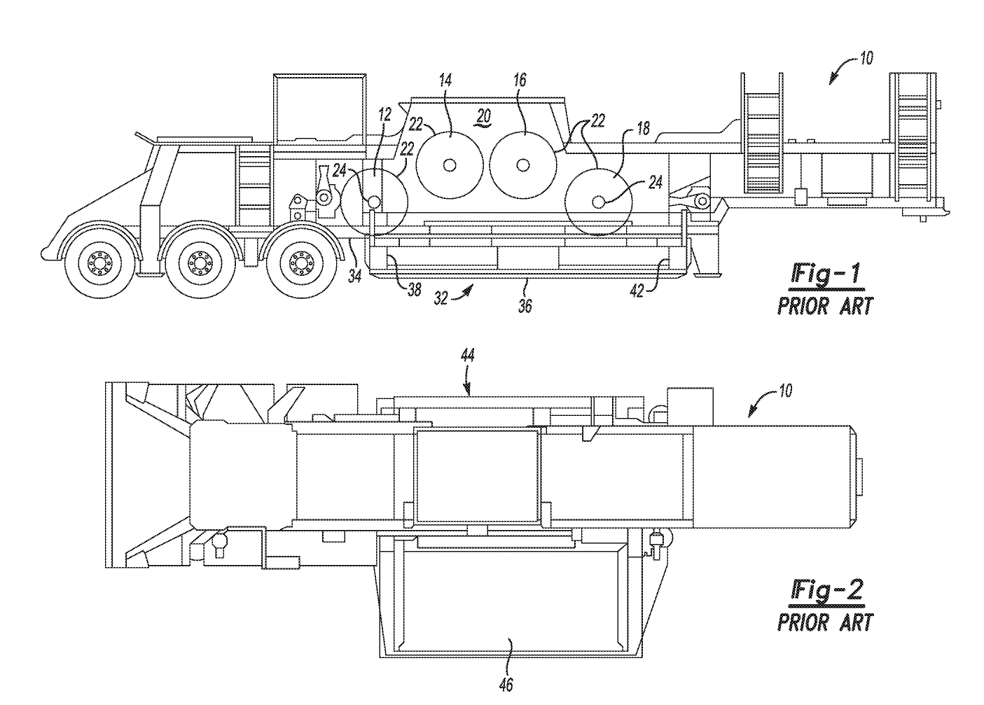

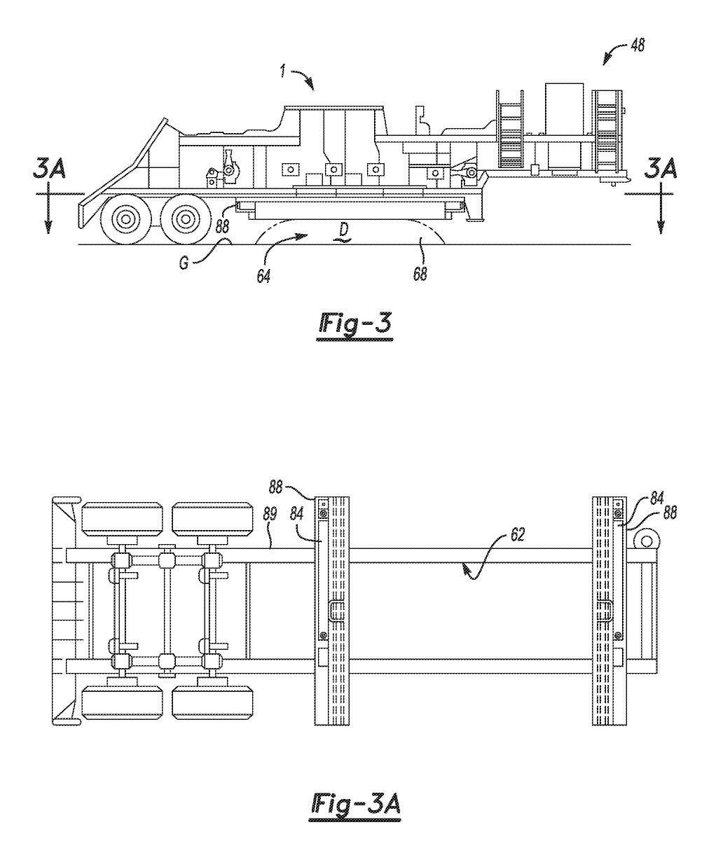

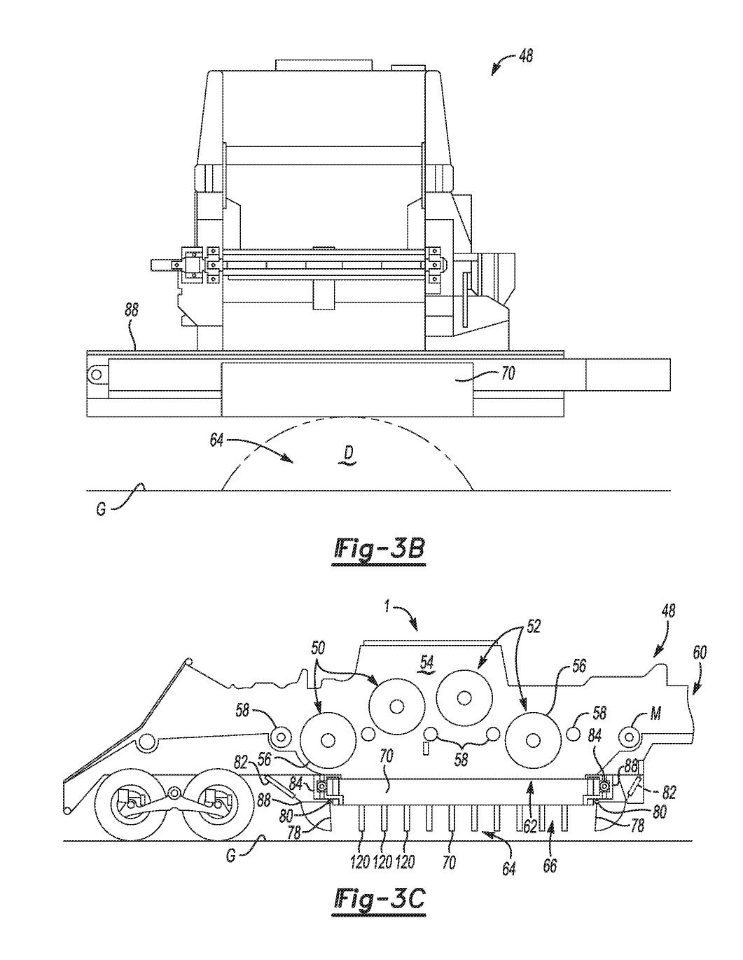

Turning now to FIGS. 3, and 3A-3C, a brief description concerning the various components of the present invention will now be briefly discussed. As can be seen in this embodiment, the chain flail debarking apparatus 48 typically includes at least two pairs of flail assemblies 50, 52 (four flail assemblies are shown in FIG. 3C of the drawings) which are located within a flail section 54 of the debarking enclosure 1, so as to enable the log(s), slab(s), trunk(s), etc., to pass therethrough. Flail assemblies 50 and 52 may, but need not, be similar or identical to the flail assemblies 12, 14, 16, and 18 of FIG. 1 which are well known in the art. Each of the flail assemblies 50, 52 supports a plurality of chain flails 56 also referred to as flail chains 56 (only diagrammatically shown) for engaging, pounding and abrading against the exterior surface of the log(s), slab(s), trunk(s), etc., to cut, dislodge and/or remove limbs, branches and/or other debris D as well as much bark as possible therefrom.

Each of the flail assemblies 50, 52 typically includes a horizontal arranged shaft that is operatively connected (not shown) to a conventional drive apparatus (not shown) for supplying rotational drive thereto. Due to this arrangement, as the shafts of the flail assemblies 50, 52 rotate, the supported flail chains 56 are directed outwardly, by centrifugal force, in a substantial radial direction. As the log(s), slab(s), trunk(s), etc., pass through the flail section 54, the flail chains 56 engage, pound and abrade against the exterior surface of the log(s), slab(s), trunk(s), etc., and cut, dislodge and/or to remove limbs, branches and/or other debris D as well as much bark as possible therefrom.

As is also conventional in the art, a plurality of spaced apart un-powered and powered transfer rollers 58, are located within the flail section 54 to assist with conveying of the log(s), slab(s), trunk(s), etc., to be delimbed and/or debarked, through the flail section 54. Debarked log(s), slab(s), trunk(s), etc., eventually exit the flail section 54 and are subsequently transferred from the discharge outlet 60 of the flail section 54, onto a conveyor belt or some other conventional transfer mechanism. M for subsequent processing by desired equipment, e.g., a disc chipper.

As is also conventional in the art, a vertically lower most surface of the flail section 54 of the chain flail debarking apparatus 48 comprises a generally rectangular vertical opening 62 which permits the dislodged bark, limbs, leaves, branches and/or other debris D to fall freely, due to gravity, vertically downward onto a debris collection area 64 which is located vertically below the rectangular vertical opening 62 of the flail section 54 and to the ground G. Unlike the prior art, however, the debris collection area 64 does not comprise a debris collection box or any other structure other than a plunger assembly 66. That is, the debris collection box is completely eliminated and replaced with the much larger debris collection area 64 so that the debris collection area 64 is able to accommodate a much larger volume or quantity of debris D before the plunger must be cycled to discharge the accumulated debris D from the debris collection area 64, as will be described in further detail below. The rectangular vertical opening 62 typically has a length of between 11 and 13 feet and a width of approximately 60 inches. It is to be appreciated that the overall shape and size of the rectangular vertical opening 62 can vary from application to application, depending upon the particular requirements.

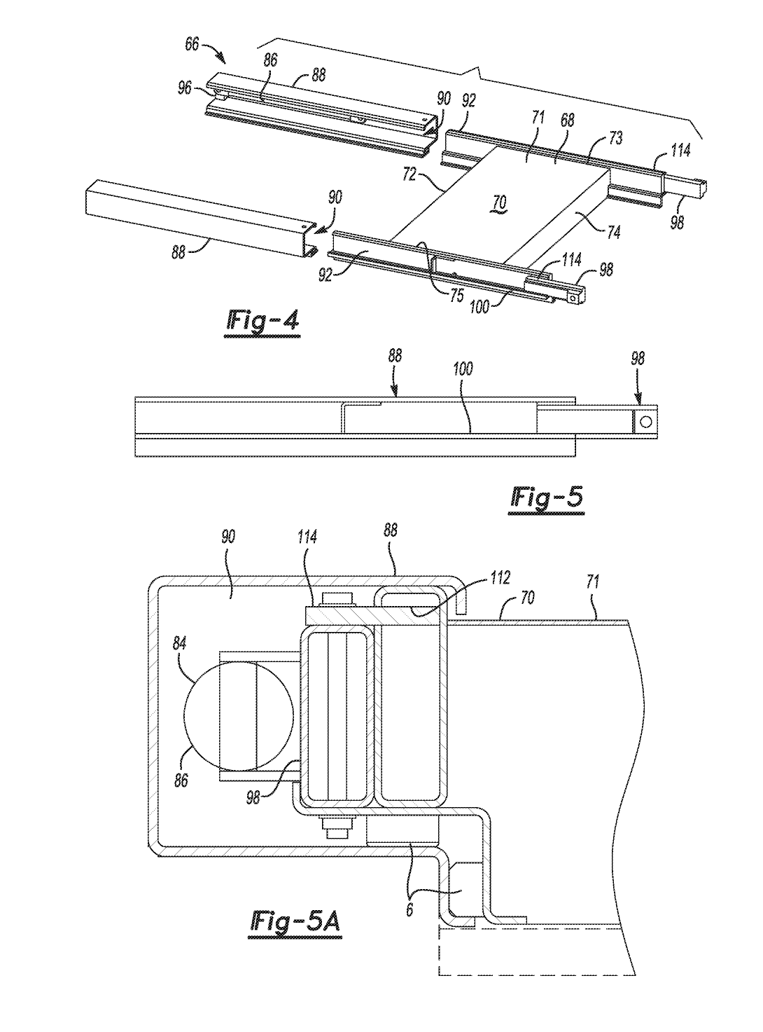

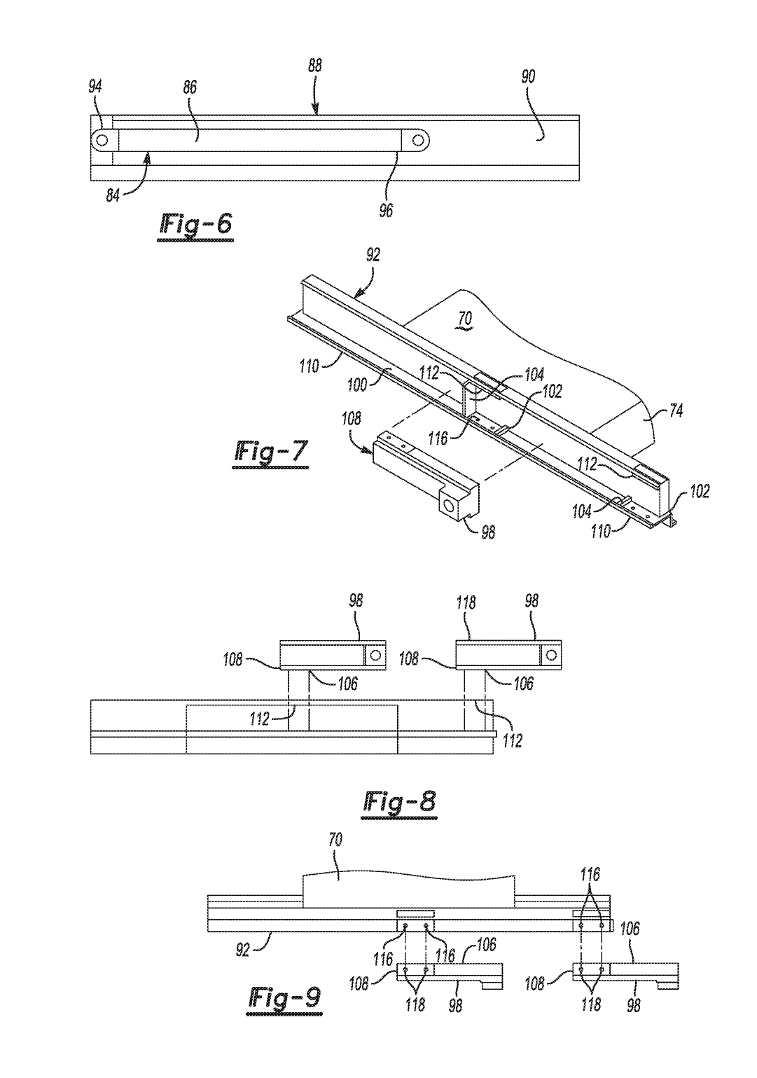

As also shown in FIGS. 3-8, a brief description concerning the various components of the plunger assembly 66, according to the present invention, will now be briefly discussed. As can be seen in this embodiment, the chain flail debarking apparatus 48 includes a plunger assembly 66 which is located vertically beneath the rectangular vertical opening 62 of the flail section 54 of the chain flail debarking apparatus 48. As shown in FIGS. 4 and 6, the plunger assembly 66 includes a generally hollow plunger 68 which comprises a plunger body 70 that has, for example, a length of between 11 and 13 feet, a width of about 60 to 74 inches, and a height or thickness of between 6 inches and 18 inches, and more preferably a height or thickness of about 12 inches. The plunger body 70 is preferably enclosed on at least five and normally six sides or surfaces, namely, the plunger body 70 has a continuous top surface 71, a continuous left side plunging surface 72, a continuous leading end surface 73, a continuous right side plunging surface 74 and a continuous trailing end surface 75, and normally a continuous bottom surface 76 (although this is not absolutely necessary). The plunger body 70 and each of the sidewall surfaces thereof must have sufficient wall thickness and/or integrity so as to resist deformation during use of the plunger 68 while avoiding adding excess weight to the chain flail debarking apparatus 48. The top surface 71 is also preferably smooth, continuous and flat so as to facilitate a sliding plunging motion with the top surface 71 of the plunger 68 in very close proximity to the opening in the bottom surface of the chain flail debarking apparatus 48, which defines the rectangular vertical opening 62.

Preferably, the width of the plunger body 70 is at least 6 inches wider than the width of the rectangular vertical opening 62 so that, regardless of the position of the plunger body 70 during the plunging motion of the plunger body 70, the top surface 71 of the plunger body 70 generally engages with the trailing longitudinal edge of the chain flail debarking apparatus 48 which defines the rectangular vertical opening 62. Such engagement prevents any new debris, which is generated within the flail section 54, from falling toward the debris collection area 64, during cycling of the plunger body 70, and potentially jamming, hindering or obstructing the return stroke of the plunger 68. This additional width of the plunger body 70 permits the leading plunging surface 72 or 74 of the plunger 68 to extend at least 4 inches past the leading longitudinal trailing edge of the chain flail debarking apparatus 48 which defines the rectangular vertical opening 62 while the top surface 71 of the plunger body 70 still prevents the trailing side surface 74 or 72 of the plunger body 70 from communicating with the trailing longitudinal edge of the rectangular vertical opening 62. It is to be appreciated that the overall size and shape of the plunger body 70 can vary, from application to application, without departing from the spirit and scope of the present invention.

The debris collection area 64 typically has a length of between 11 and 13 feet, a width of at least 60 to 74 inches, and a height or thickness of between 14 inches and 24 inches or so, depending upon the ground clearance C between the bottom surface of the debarking chain flail apparatus 48 and the ground G. It is to be appreciated that the overall length, width and height dimensions of the debris collection area 64 can vary and are dictated somewhat by the general contour of the terrain upon which the chain flail debarking apparatus 48 is currently supported.

As shown in FIG. 3C, a pair of opposed retractable containment barrier 78 can be provided to assist with increasing containment and/or confinement of the removed limbs, branches, bark and/or other debris D within the debris collection area 64. For example, a longitudinal edge 80 of a first retractable containment barrier 78 can be hingedly connected to an undersurface of the chain flail debarking apparatus 48, generally parallel to and closely adjacent a leading edge of the rectangular vertical opening 62 while a longitudinal edge 80 of a second retractable containment barrier 78 can be hingedly connected to an undersurface of the chain flail debarking apparatus 48, parallel to and closely adjacent a trailing edge of the rectangular vertical opening 62. Each one of the pair of opposed retractable containment barrier 78 can be either manually manipulated, by an operator, into either an operative position, in which the retractable containment barrier 78 is latched in an operative position, by a conventional member 82, to confine the generated debris D, and a stowed position, in which the retractable containment barrier 78 is inoperative and stored for transportation. Alternatively, the pair of opposed retractable containment barriers 78 may be respectively moved by actuation of a pair of respective conventional barrier hydraulic cylinders, also generally indicated by reference numeral 82. In the event that barrier hydraulic cylinders 82 are utilized for operation of the retractable containment barriers 78, a first end hydraulic cylinder 82 is pivotally supported by an undersurface of the chain flail debarking apparatus 48 while a second end of the respective hydraulic cylinder 82 is pivotally attached to a respective one of the retractable containment barriers 78, remote from the hingedly connection horizontal edge, to facilitate movement of the retractable containment barriers 78 into either their operative or their stowed positions.

As generally shown in the drawings, the pair of the retractable containment barriers 78 each have a dimension such that the retractable containment barriers 78 will be spaced from the ground during use, e.g., the pivoted longitudinal edge of each retractable containment barrier 78 is typically spaced from the ground by about 6 to 8 inches±3 inches.

Once a sufficient amount of dislodged bark, limbs, leaves, branches and/or other debris D accumulates or collects within the debris collection area 64, the plunger 68 is actuated, by operation of a pair of plunger hydraulic cylinders 84, to move the plunger body 70 from its extended (plunged) or retracted (initial) position into its opposite retracted (initial) or extended (plunged) position, as discussed hereinafter in further detail, in order to push and/or force the accumulated bark, limbs, leaves, branches and/or other debris D out of the debris collection area 64 so that additional bark, limbs, leaves, branches and/or other debris D can fall into and accumulate in the debris collection area 64. After completion of the pushing or plunging stroke of the plunger 68, the plunger hydraulic cylinders 84 automatically return the plunger 68 back to its normally retracted position in anticipation of a further plunging stroke after a sufficient amount of dislodged bark, limbs, leaves, branches and/or other debris D again accumulates within the debris collection area 64. This pushing motion of the plunger 68 is repeated, as necessary, during operation of the chain flail debarking apparatus 48, e.g., typically once every 30 seconds or so to a few minutes or so.

With reference now to FIGS. 4-9, in further description concerning the various components of the plunger assembly 66, as well is its actuation, will now be described.

The plunger assembly 66 includes first and second opposed mounting frames 88 which each has a length of preferably 11 feet or less in order to facilitate travel of the debarking chain flail apparatus 48 on a public road (the plunger assembly 66 is typically the widest component of the debarking chain flail apparatus 48). Each one of the mounting frames 88 is secured to the undersurface of the chain flail debarking apparatus 48 in a conventional manner, e.g., a plurality of conventional fasteners which are not shown in detail. The mounting frames 88 may be attached directly or indirectly to the vehicle frame 89 on the underside of the chain flail debarking apparatus 48. The first mounting frame 88 is mounted closely adjacent and extends parallel to the leading edge of the rectangular vertical opening 62 while the second mounting frame 88 is mounted closely adjacent and parallel to the trailing edge of the rectangular vertical opening 62. Each one of the first and the second mounting frames 88 has a generally C-shaped transverse profile which defines a generally C-shaped recess 90.

As shown in FIG. 4, the plunger assembly 66 further comprises first and second opposed plunger rails 92 which are interconnected together with one another via the plunger body 70. Preferably each of the six surfaces, namely, the top surface 71, the left side plunging surface 72 or left side pushing surface 72, the leading end surface 73, the right side plunging surface 74 or right side pushing surface 74, the trailing end surface 75, and the bottom surface 76 of the plunger body 70 are continuous solid surfaces. The first plunger rail 92 is captively received within and guided by the generally C-shaped recess 90 of the first mounting frame 88 while the second plunger rail 92 is captively received within and guided by the generally C-shaped recess 90 of the second mounting frame 88. A plurality of bearings are provided, between the plunger rails and the respective mounting frames, to facilitate relative movement. As shown in FIG. 5A, two sets of adjustable plunger guides G are provided to assist with guiding the plunger body along the mounting frames 88.

A first plunger hydraulic cylinder 84 interconnects the first mounting frame 88 with the first plunger rail 92 while a second hydraulic cylinder 84 interconnects the second mounting frame 88 with the second plunger rail 92 (see FIG. 6). Each one of the plunger hydraulic cylinders 84 generally comprises a cylinder body 86 which accommodates a slidable internal piston (not shown). The cylinder body 86 has a fixed clevis 94, located at one end thereof, which typically facilitates connection of the cylinder body 86 with the respective mounting frame 88. It is to be appreciated that for some applications, an intermediate section or an opposite end portion of the cylinder body 86 may be secured to the mounting frame 88, e.g., by a trellis or some other similar component. One end of a cylinder rod 96 is connected to a piston (not shown), which is slidably accommodated within the cylinder body 86, while the opposite end of the cylinder rod 96 is connected, via an adjustable cylinder mount 98, to the respective plunger rail 92.

As noted above, due to state and federal regulations relating to safe travel on public roads and highways, the first and the second mounting frames 88 typically have a maximum length of 11 feet. The length of the mounting frames 88 dictates the maximum length of the hydraulic cylinder, i.e., the cylinder body 86 and the cylinder rod 96, that can be readily accommodated by the mounting frames 88. According to these parameters, the maximum stroke of the cylinder rod 96 is approximately 72 inches. It is to be appreciated that a cylinder rod 96 with a longer stroke, although desirable, cannot be readily accommodated within mounting frames 88 which have a maximum length of 11 feet.

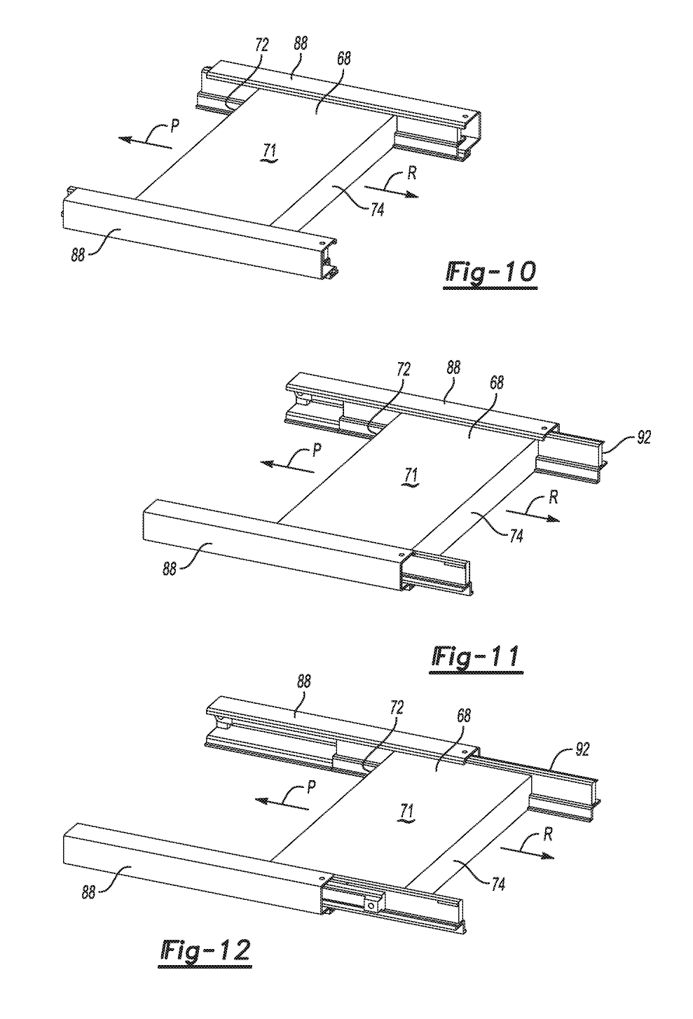

As shown in FIGS. 7-9, the adjustable cylinder mount 98 may be connected to the respective plunger rail 92 in either a first position (shown in an intermediate portion of the FIGS. 8 and 9), which facilitates left side discharge of debris D or a second position (shown on the right side of the FIGS. 8 and 9), which facilitates right side discharge of debris D. Discharge of the debris Din both discharge directions will be discussed hereinafter in further detail with reference to FIGS. 10-15. Each one of the first and the second plunger rails 92 comprises a vertical rail shelf 100 upon which the adjustable cylinder mount 98 is vertically supported. Each rail shelf 100 has first and second pairs of first and second stop members 102, 104 which cooperate with mating stop features 106, 108 of the adjustable cylinder mount 98 so as to prevent relative motion between the adjustable cylinder mount 98 and the associated plunger rail 92. The first stop feature 106 is a rectangular stop recess, formed in the bottom surface of the adjustable cylinder mount 98, while the second stop feature 108 is an end surface or wall of the adjustable cylinder mount 98. The first stop recess 106 of each one of the adjustable cylinder mounts 98 intimately receives and engages with a mating first stop member 102 of the rail shelf 100, while the end wall or surface 108 of the adjustable cylinder mount 98 mating engages with the second stop member 104 of the rail shelf 100. The mating pairs of the first and the second stop members/features 102, 104, 106, 108 prevent axial movement of each respective adjustable cylinder mounts 98 with respect to the associated plunger rail 92.

A lateral guide 110 extends along each one of the plunger rails 92 so as to confine the adjustable cylinder mount 98 and prevent lateral movement of the adjustable cylinder mount 98 with respect to the plunger rail 92. In order to ensure captive retainment of the adjustable cylinder mount 98 with respect to the respective plunger rail 92, each one of the plunger rails 92 is provided with a pair of spaced apart rectangular shaped cavities 112 which generally extend parallel to the rail shelf 100. A rectangular retainer plate 114 is sized so as to be received within a respective one of the cavities 112 and still project outwardly therefrom so as to assist with captively retaining the adjustable cylinder mount 98 in engagement with the associated plunger rail 92 and thereby prevent any vertically upward movement of the adjustable cylinder mount 98 with respect to the associated plunger rail 92 and thereby maintain secure engagement of the first and second stop members/features 102, 104, 106, 108 with one another. Preferably, the retainer plate 114 has one or more holes 116 formed therein which are aligned with one or more mating holes 118 formed in a top surface of the adjustable cylinder mount 98. A pin, screw, or some other fastening device facilitates releasable connection of the adjustable cylinder mount 98 to the retainer plate via the mating holes 116, 118.

When adjustment of the adjustable cylinder mount 98 is desired, e.g., either adjustment of the adjustable cylinder mount 98 from the first position into the second position or vice versa, the pin(s), screw(s), or other fastening device(s) are first removed from the retainer plate 114 and, thereafter, the retaining plate 114 is removed from the associated cavity 112. Now each one of the adjustable cylinder mounts 98 can be vertically lifted manually by a sufficient distance, e.g., an inch or so, with respect to the associated plunger rail 92 so as to disengage the first and second stop features 106, 108 of the adjustable cylinder mount 98 from the mating first and second stop members 102, 104 of the associated plunger rails 92. While each of the adjustable cylinder mounts 98 remains lifted, each one of the plunger rails 92 is manually moved, relative to the adjustable cylinder mount 98, approximately 60 inches so that the adjustable cylinder mounts 98 become properly aligned with the other pair of the first and the second stop members 102, 104 of the associated plunger rail 92. Once each adjustable cylinder mount 98 is properly aligned with the respective plunger rail 92, the adjustable cylinder mounts 98 are then gently lowered onto the respective plunger rails 92 so that the first and the second stop features 106, 108, of the adjustable cylinder mounts 98, respectively received and engage with corresponding stop members 102, 104, of the plunger rail 92. The retaining plate 114 is then inserted into the associated cavity 112 and finally the pin(s), screw(s), or other fastening device(s) is/are inserted into the holes 116 of the retainer plate 114 so as to captively retain the adjustable cylinder mount 98 in engagement with the associated plunger rail 92.

With reference now to FIGS. 10-12, the associated arrangement and plunging motion, which facilitates left side discharge of the debris D from the chain flail debarking apparatus 48, will now be discussed.

In order to achieve left side discharge of debris D from the chain flail debarking apparatus 48, it is to be appreciated that the adjustable cylinder mounts 98 must be mounted in their first position, e.g., spaced from the ends of the plunger rails 92. As shown in FIG. 10, the plunger assembly 66 is shown generally in its end plunging position (this is also a traveling position of the plunger assembly 66). In order to facilitate plunging of debris D, the hydraulic cylinders 84 are simultaneously actuated to move the plunger 68, in a retraction direction indicated by arrow R, away from the end position shown in FIG. 10, toward an intermediate position shown in FIG. 11, and finally to an initial plunging position shown in FIG. 12. Once the plunger 68 is located in this position, the operator can then commence operation of the chain flail debarking apparatus 48 to remove bark, limbs, branches and/or other debris D as well as bark from the processed log(s), slab(s), trunk(s), etc., and allow the same to fall into the debris collection area 64. If the debarking chain flail apparatus 48 is provided with a pair of retractable containment barriers 78, they are typically deployed/moved into their operative positions to assist with confining the removed bark, limbs, branches and/or other debris D within the debris collection area 64, prior to commencing operation of the debarking chain flail apparatus 48.

Once a sufficient amount of bark, limbs, leaves, branches and/or other debris D accumulates within the debris collection area 64, the plunger 68 commences its plunging cycle. The hydraulic cylinders 84 are actuated so as to move the plunger 68, in the plunging direction indicated by arrow P, from the initial position shown in FIG. 12, toward the intermediate plunging position shown in FIG. 11, and finally to the end plunging position shown in FIG. 10. As the plunger 68 moves from its initial position (see FIG. 12) into its end plunging position (see FIG. 10), the leading pushing surface 72 of the plunger 68 pushes and/or forces the accumulated bark, limbs, leaves, branches and/or other debris D, contained within the debris collection area 64, toward a removal area which is located and spaced at least 12 inches away from the debris collection area 64. Once the plunged bark, limbs, leaves, branches and/or other debris Dare pushed into the removal area, the plunged bark, limbs, leaves, branches and/or other debris D can be readily accessed, removed, disposed of, subsequently processed, etc., by conventional equipment.

After completion of the plunging stroke, the plunger hydraulic cylinders 84 are simultaneously actuated, in the reverse direction, to return the plunger 68, in the retraction direction indicated by arrow R, from the end plunging position shown in FIG. 10, toward the intermediate position shown in FIG. 11, and finally back to the initial plunging position shown in FIG. 12 where the plunger 68 is again properly positioned for a subsequent plunging stroke once a sufficient amount of bark, limbs, leaves, branches and/or other debris D accumulates within the debris collection area 64.

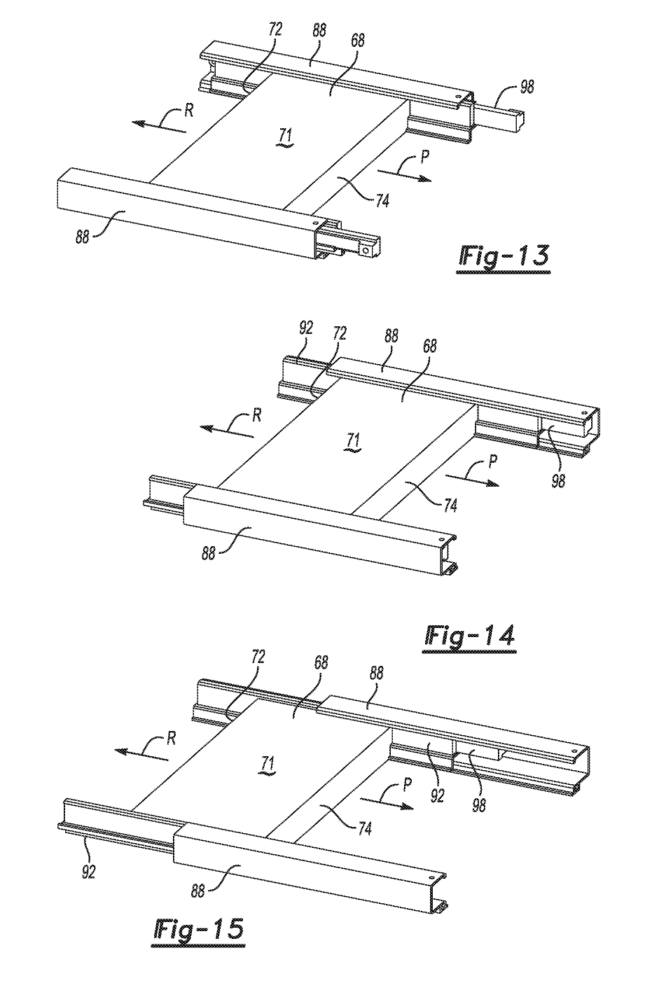

In order to achieve right side discharge of debris D from the chain flail debarking apparatus 48, it is to be appreciated that the adjustable cylinder mounts 98 must be mounted into their second position, e.g., located closely adjacent the ends of the respective plunger rails 92. As shown in FIG. 13, the plunger assembly 66 is shown generally in its end plunging position. In order to facilitate plunging of debris D, the plunger hydraulic cylinders 84 are simultaneously actuated to move the plunger 68, in a retraction direction indicated by arrow R, from the end position shown in FIG. 13, toward an intermediate position shown in FIG. 14, and finally to an initial plunging position shown in FIG. 15. Once the plunger 68 is located in this position, the operator can then commence operation of the chain flail debarking apparatus 48 to remove limbs, branches and/or other debris D as well as bark from the processed log(s), slab(s), trunk(s), etc., and allow the same to fall into the debris collection area 64. If the debarking chain flail apparatus 48 is provided with a pair of retractable containment barriers 78, they are typically deployed/moved into their operative positions to assist with confining the removed bark, limbs, branches and/or other debris D within the debris collection area 64, prior to commencing operation of the debarking chain flail apparatus 48.

Once a sufficient amount of bark, limbs, leaves, branches and/or other debris D accumulates within the debris collection area 64, the plunger 68 commences its plunging cycle. The plunger hydraulic cylinders 84 are actuated so as to move the plunger 68, in the plunging direction indicated by arrow P, from the initial position shown in FIG. 15, toward the intermediate plunging position shown in FIG. 14, and finally to the end plunging position shown in FIG. 13. As the plunger 68 moves from its initial position (see FIG. 15) toward its end plunging position (see FIG. 13), the leading pushing surface 74 of the plunger 68 pushes or forces the accumulated bark, limbs, leaves, branches and/or other debris D, contained within the debris collection area 64, into a removal area located and spaced at least 12 inches away from the debris collection area 64. Once the plunged bark, limbs, leaves, branches and/or other debris D are pushed into the removal area, the plunged bark, limbs, leaves, branches and/or other debris D can be readily accessed, removed, disposed of, subsequently processed, etc., by conventional equipment.

After completion of the plunging stroke, the plunger hydraulic cylinders 84 are simultaneously actuated, in the reverse direction, to return the plunger 68, in the retraction direction indicated by arrow R, from the end plunging position shown in FIG. 13, toward an intermediate position shown in FIG. 14, and finally back into the initial plunging position shown in FIG. 15 where the plunger 68 is again properly positioned for a subsequent plunging stroke once a sufficient amount of bark, limbs, leaves, branches and/or other debris D accumulates in the debris collection area 64.

In order to facilitate a more complete pushing of the accumulated bark, limbs, leaves, branches and/or other debris D from the debris collection area 64, a leading end or surface of the plunger 68 can be provided with a set of retractable rakes 120, e.g., a plurality of spaced apart rakes 120 which are pivotably supported along a shaft (not shown in detail). Each one of the rakes 120 has an operational position, in which the rakes 120 are rotated downwardly as to be positioned for engagement with the accumulated bark, limbs, leaves, branches and/or other debris D which collects in the debris collection area 64, and a stowed position, in which the rakes 120 are retracted and spaced from the debris collection area 64 so as to be inoperative.

As shown in FIG. 3C, the set of retractable rakes 120 are shown in their use position adjacent a leading surface of the plunger 68 and arranged so as to engage with the bark, limbs, leaves, branches and/or other debris D which accumulates in the vertically lower portion of the debris collection area 64. Preferably a leading end of each one of the rakes 120 is spaced approximately 6 inches or so from the ground so as not to hinder or obstruct the desired raking action. If desired, each rake 120 may be spring biased into a raking position by a conventional spring (not shown) Which facilitates a partial rake retraction movement in the event that the rake 120 abuts against an obstruction, e.g., a rock or stump for example. Preferably each leading surface of the plunger 68 is provided with a set of rakes 120 but only one set of rakes 120 is utilized during the plunging stroke of the plunger assembly 66, e.g., the first set of rakes 120 is arranged to assist with left side discharge plunging of debris D, while the second set of rakes 120 is arranged to assist with right side discharge plunging of debris D.

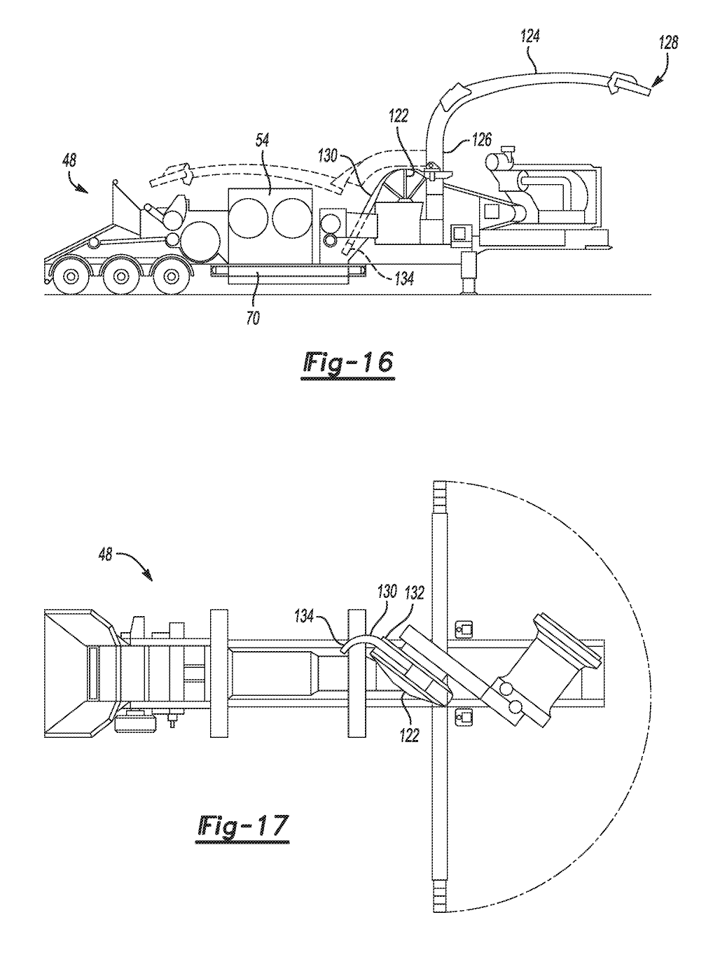

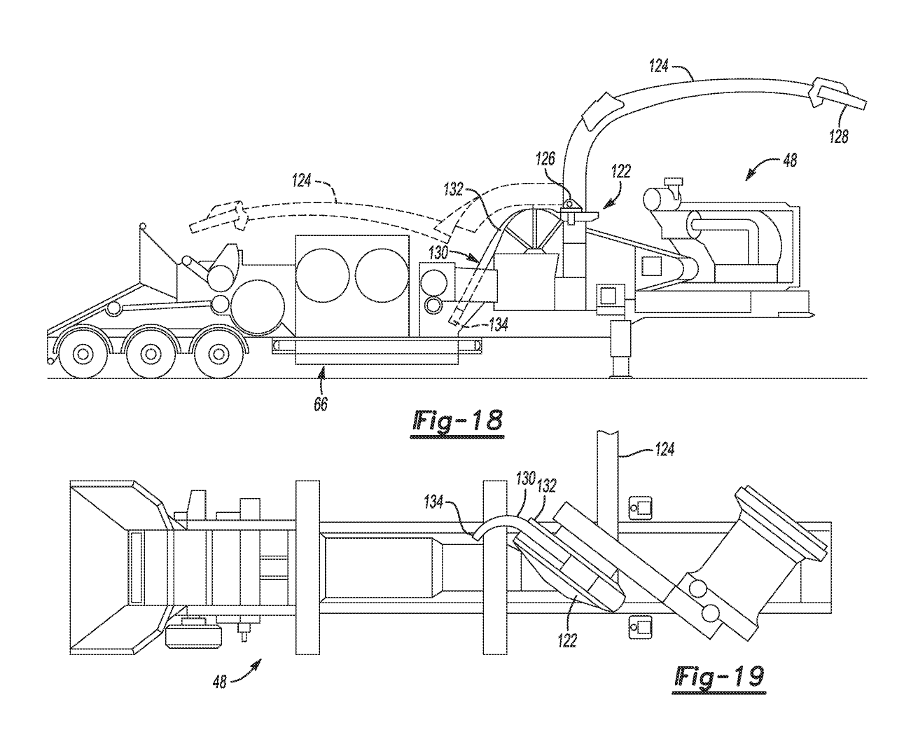

While debarking chain flail apparatus 48, shown in the above discussed embodiment, is not shown with any processing equipment mounted adjacent the discharge outlet 60 of the flail section 54, it is to be appreciated that a variety of different pieces of equipment may be supported by the debarking chain flail apparatus 48 to facilitate further processing of the delimbed and/or debarked log(s), slab(s), trunk(s), etc. For example, as generally shown in FIGS. 16-19, a conventional disk chipper 122 may be supported adjacent the discharge outlet 60 of the flail section 54. As a result of such arrangement, the delimbed and/or debarked log(s), slab(s), trunk(s), etc., are then available to be directly fed into the inlet of the disc chipper 122 for processing, in a conventional manner, into chips of a desired chip size.

As shown in FIG. 16, the disk chipper 122 is supported adjacent a leading end of the debarking chain flail apparatus 48 and is equipped with a discharge chute 124. The discharge chute 124 is pivotally supported on the disc chipper 122 and the discharge chute 124 has both a partially disassembled storage position (shown in dashed lines) as well as use position. The discharge chute 124 has a chute inlet 126 and a chute outlet 128 located at the opposite end thereof. As shown in FIG. 17, the discharge chute 124 can be rotated into a plurality of different discharge orientations which facilitate discharging the generated chips on either the left side or the right side of the debarking chain flail apparatus 48. That is, the discharge chute 124 typically has at least 180° of rotation with respect to the debarking chain flail apparatus 48. During use, the plunger arrangement typically facilitates discharging the removed limbs, branches and/or other debris D on one side of the debarking chain flail apparatus 48, e.g., the left side, while the discharge chute 124 facilitates discharging the generated chips on the other side of the debarking chain flail apparatus 48, e.g., the right side, or vice versa.

A novel aspect associated with the disc chipper 122 is the inclusion of a debris transfer chute 130 which facilitates discharge of the debris generated by the disk chipper 122. An inlet end 132 of the debris transfer chute 130 is coupled to the disc chipper 122 and arranged to collect the associated debris which is generated by the disk chipper 122 during operation. An outlet end 134 of the debris transfer chute 130 is located to discharge the debris, generated by the disk chipper 122, into the debris collection area 62 where the debris, generated by the disk chipper 122, can be discharged, toward either the left side or the right side of the debarking chain flail apparatus 48, along with the removed limbs, branches and/or other debris D.

Preferably, the debris transfer chute 130 has a cross-sectional area of between about 150 and 20 square inches, more preferably has a cross-sectional area of about 60 inches. The debris transfer chute 130 preferably has a gradual transition or bend, from the inlet end 132 to the outlet end 134, which avoids accumulation of any of the debris along the debris transfer chute 124 during operation.

Preferably, the plunger assembly 66 is electrically connected with a control panel, which incorporates a processor, to monitor accumulation of the removed bark, limbs, branches and/or other debris D within the debris collection area 62, via sensor and periodic cycling of the plunger, as necessary, to remove the accumulated bark, limbs, branches and/or other debris D from the debris collection area 64.

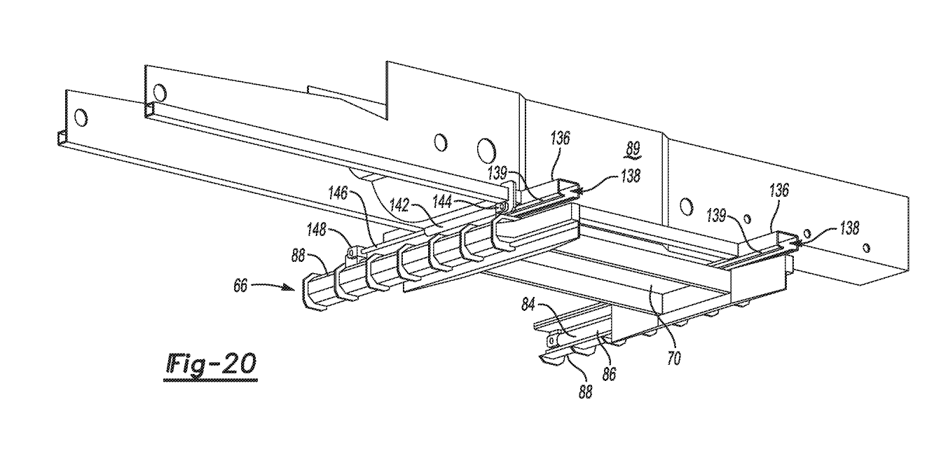

Turning now to FIGS. 20-24B, a second embodiment of the present invention will now be described. As this embodiment is very similar to the previously discussed embodiment, only the differences between this new embodiment and the previous embodiment will be discussed in detail while identical elements will be given identical reference numerals.

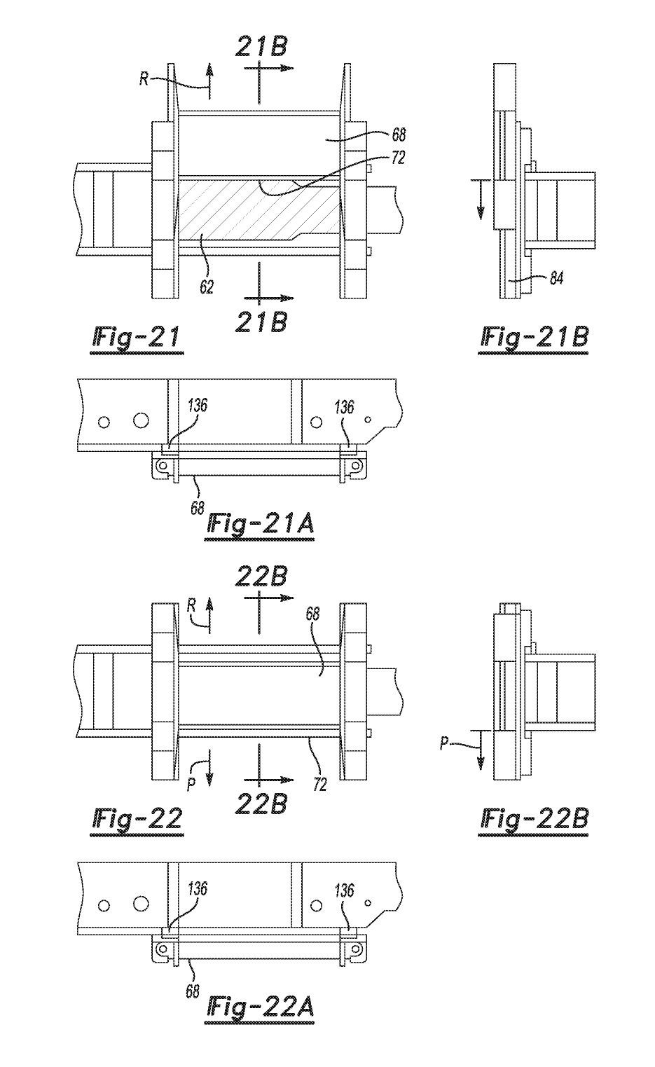

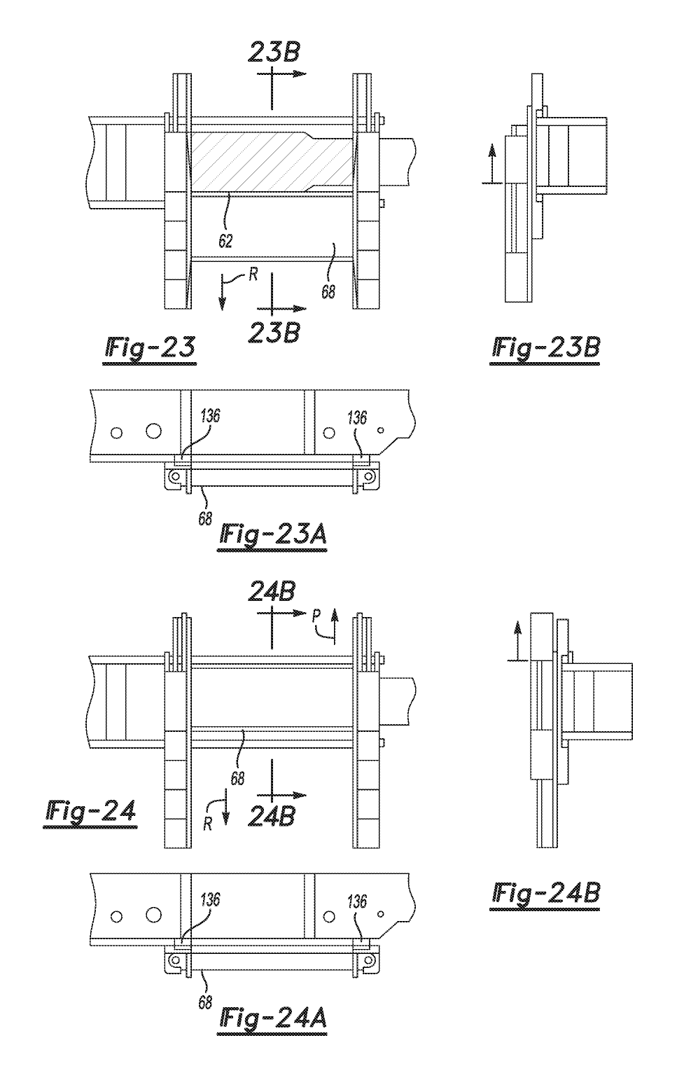

A first difference, between the second embodiment and the previous embodiment, is that the width of the rectangular vertical opening 62 of the discharge outlet 60 is only 48 inches wide (see FIGS. 21 and 23, for example), instead of having a width of 60 inches.

A second difference is that the plunger assembly further includes first and second plunger cradles 136 which are fixedly secured (e.g., by welding or by a plurality of conventional fasteners) to the frame 89 or the undersurface of the chain flail debarking apparatus 48, instead of the first and second mounting frames being secured thereto. Each one of the first and the second plunger cradles 136 generally has an inverted C-shape recess 138. The first mounting frame 88 is captively received within and movable guided by the inverted C-shaped recess 138 of the first plunger cradle 136 while the second mounting frame 88 is captively received within and movable guided by the inverted C-shaped recess 138 of the second plunger cradle 136. A plurality of bearings 139 (not shown in detail) are provided, between the mounting frames and the respective first and second plunger cradles 136 to facilitate relative movement.

A third difference is that a first cradle hydraulic cylinder 140 couples the first plunger cradle 136 with the first mounting frame 88 while a second cradle hydraulic cylinder 140 couples the second plunger cradle 136 with the second mounting frame 88. Each of the first and the second cradle hydraulic cylinders 140 typically has a stroke of 48 inches so that the first and the second mounting frames 88 can be simultaneously displaced 48 inches with respect to the first and the second cradles 136 and a remainder of the chain flail debarking apparatus 48 during left side plunging, as will be discussed below in further detail.

As with the previous embodiment, the first cradle 136 is mounted closely adjacent and extends parallel to the leading edge of the rectangular vertical opening 62 while the second cradle 136 is mounted closely adjacent and parallel to the trailing edge of the rectangular vertical opening 62. The first cradle hydraulic cylinder 140 couples an end portion of the first cradle 136 with the first mounting frame 88 while a second cradle hydraulic cylinder 140 couples an end portion of the second cradle 136 with the mounting frame 88 (see FIG. 20).

Each one of the cradle hydraulic cylinders 140 generally comprises a cylinder body 142 which accommodates a slidable internal piston (not shown). The cradle cylinder body 142 has a fixed clevis 144, located adjacent one end thereof, which facilitates connection of the cradle cylinder body 142 with either a respective one of the first or the second cradles 136 or directly to the frame of the chain flail debarking apparatus 48. A first end of a cradle cylinder rod 146 is connected to a piston (not shown), which is slidably accommodated within the cradle cylinder body 142, while the opposite end of the cradle cylinder rod 146 is connected, via a clevis 148, to one of the first and the second mounting frames 88.

Due to this arrangement, when both of the cradle hydraulic cylinders 140 are in a retracted position (see FIGS. 21 and 22), this facilitates right side plunging discharge while when both of the cradle hydraulic cylinders 140 are in their extended position, this facilitates left side plunger discharge (see FIGS. 23 and 24).

With reference now to FIGS. 21-22B, the associated arrangement and plunging motion, which facilitates right side discharge of the debris D from the chain flail debarking apparatus 48, will now be discussed.

In order to achieve right side discharge of debris D from the chain flail debarking apparatus 48, it is to be appreciated that the cradle hydraulic cylinders 140 must be in their retracted positions so that the first and the second mounting frames 88 generally coincide with the first and second plunger cradles 136. As shown in FIG. 22, the plunger assembly 66 is shown generally in its end plunging position (this is also a traveling position of the plunger assembly 66). In order to facilitate plunging of debris D, the plunger hydraulic cylinders 84 are simultaneously actuated to move the plunger 68 in a retraction direction, indicated by arrow R, away from the end position shown in FIG. 22 and into an initial plunging position shown in FIG. 21. Once the plunger 68 is located in this position, the operator can then commence operation of the chain flail debarking apparatus 48 to remove bark, limbs, branches and/or other debris D as well as bark from the processed log(s), slab(s), trunk(s), etc., and allow same to fall into the debris collection area 64. If the debarking chain flail apparatus 48 is provided with a pair of retractable containment barriers 78, they are typically deployed/moved to their operative positions to assist with confining the removed bark, limbs, branches and/or other debris D within the debris collection area 64, prior to commencing operation of the debarking chain flail apparatus 48.

Once a sufficient amount of bark, limbs, leaves, branches and/or other debris D accumulates within the debris collection area 64, the plunger 68 commences its plunging cycle. The hydraulic cylinders 84 are actuated so as to move the plunger 68, in the plunging direction indicated by arrow P, from the initial position shown in FIG. 21, to the end plunging position shown in FIG. 22. As the plunger 68 moves from its initial position (see FIG. 21) into its end plunging position (see FIG. 22), the leading pushing surface 72 of the plunger 68 pushes and/or forces the accumulated bark, limbs, leaves, branches and/or other debris D, contained within the debris collection area 64, toward a removal area which is located and spaced about 7 inches away from the debris collection area 64. Once the plunged bark, limbs, leaves, branches and/or other debris D are pushed into the removal area, the plunged bark, limbs, leaves, branches and/or other debris D can be readily accessed, removed, disposed of, subsequently processed, etc., by conventional equipment.

After completion of the plunging stroke, the plunger hydraulic cylinders 84 are simultaneously actuated, in the reverse direction, to return the plunger 68, in the retraction direction indicated by arrow R, from the end plunging position shown in FIG. 22 and back to the initial plunging position shown in FIG. 21 where the plunger 68 is again properly positioned for a subsequent plunging stroke once a sufficient amount of bark, limbs, leaves, branches and/or other debris D accumulates within the debris collection area 64.

In order to achieve left side discharge of debris D from the chain flail debarking apparatus 48, it is to be appreciated that the cradle hydraulic cylinders 140 must be in their extend positions so that the first and the second mounting frames 88 generally extend or project, to some extent, respectively from the first and the second plunger cradles 136. That is, the cradle hydraulic cylinders 140 are actuated so as to move the first and the second mounting frames 88 relative to the first and the second cradles 136 thereby increasing the overall total axial length of the plunger assembly 66.

As shown in FIG. 24, the plunger assembly 66 is shown generally in its end plunging position. In order to facilitate plunging of debris D, the plunger hydraulic cylinders 84 are simultaneously actuated to move the plunger 68, in a retraction direction indicated by arrow R, from the end position shown in FIG. 24 into an initial plunging position shown in FIG. 23. Once the plunger 68 is located in this position, the operator can then commence operation of the chain flail debarking apparatus 48 to remove limbs, branches and/or other debris D as well as bark from the processed log(s), slab(s), trunk(s), etc., and allow the same to fall into the debris collection area 64. If the debarking chain flail apparatus 48 is provided with a pair of retractable containment barriers 78, they are typically deployed/moved to their operative positions to assist with confining the removed bark, limbs, branches and/or other debris D within the debris collection area 64, prior to commencing operation of the debarking chain flail apparatus 48.

Once a sufficient amount of bark, limbs, leaves, branches and/or other debris D accumulates within the debris collection area 64, the plunger 68 commences its plunging cycle. The plunger hydraulic cylinders 84 are actuated so as to move the plunger 68, in the plunging direction indicated by arrow P, from the initial position shown in FIG. 23 to the end plunging position shown in FIG. 24. As the plunger 68 moves from its initial position (see FIG. 24) toward its end plunging position (see FIG. 24), the leading pushing surface 74 of the plunger 68 pushes or forces the accumulated bark, limbs, leaves, branches and/or other debris D, contained within the debris collection area 64, into a removal area located and spaced at least 12 inches away from the debris collection area 64. Once the plunged bark, limbs, leaves, branches and/or other debris D are pushed into the removal area, the plunged bark, limbs, leaves, branches and/or other debris D can be readily accessed, removed, disposed of, subsequently processed, etc., by conventional equipment.

After completion of the plunging stroke, the plunger hydraulic cylinders 84 are simultaneously actuated, in the reverse direction, to return the plunger 68, in the retraction direction indicated by arrow R, from the end plunging position shown in FIG. 24 and back into the initial plunging position shown in FIG. 23 where the plunger 68 is again properly positioned for a subsequent plunging stroke once a sufficient amount of bark, limbs, leaves, branches and/or other debris D accumulates in the debris collection area 64.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

1. A selectable discharge direction mobile chain flail debarking apparatus configured to be primarily transported on a highway along a longitudinal axis of the mobile chain flail debarking apparatus which comprises:
a vehicle frame 89;
a debarking enclosure 1, operatively coupled to said vehicle frame 89 and disposed around a flail section 54, said debarking enclosure being open to the ground below during operation;
a plurality of rotating flail assemblies 50 configured to remove bark from portions of logs, disposed with said debarking enclosure;
a plurality of powered transfer rollers 58 configured to propel logs through said debarking enclosure 1;
a generally rectangular vertical opening 62 located below said flail section 54;
a debris collection area 64 located vertically below said generally rectangular vertical opening 62;
first and second plunger cradles 136 which are fixedly secured to the vehicle frame 89;
first and second mounting frames 88 being secured to said first and second plunger cradles 136, respectively;
each one of the first and the second plunger cradles 136 generally has an inverted C-shape recess 138 therein;
the first mounting frame 88 is captively received within and movable guided by said inverted C-shaped recess 138 of the first plunger cradle 136;
the second mounting frame 88 is captively received within and movable guided by the inverted C-shaped recess 138 of the second plunger cradle 136;
a plurality of bearings 139 are provided, between the first and second mounting frames 88 and their respective the first and the second plunger cradles 136 to facilitate relative movement therebetween;
a plunger body 70, which is generally horizontal translatable, comprising a left side plunging surface 72 and a right side plunging surface 74; said plunger body 70 being disposed below said generally rectangular vertical opening 62, said plunger body 70 configured to move from an open position on one side of said generally rectangular vertical opening 62 to a temporary plunging position;
a plurality of spaced apart rakes 120 retractably coupled to said plunger body 70;
said plunger body 70 being oriented and configured to translate in a first discharge direction, and said plunger body 70 being oriented and configured to translate in a second and opposite discharge direction from said first discharge direction;
a first retractable containment barrier 78;
a disc chipper 122;
a debris transfer chute 130 which facilitates discharge of debris generated by said disc chipper 122; via an inlet end 132 of the debris transfer chute 130 which is coupled to the disc chipper 122 and arranged to collect any associated debris which is generated by the disk chipper 122 during operation; and
an outlet end 134 of the debris transfer chute 130 is located to discharge debris, generated by the disk chipper 122, into the debris collection area 64.

2. A selectable discharge direction mobile chain flail debarking apparatus configured to be primarily transported on a highway along a longitudinal axis of said mobile chain flail debarking apparatus which comprises:
means for structurally supporting an apparatus;
means for enclosing a flail section;
means for flailing items to remove matter attached thereto; and
means for pushing matter laterally, in opposing selectable discharge directions, from an area beneath said means for flailing items, wherein the means for pushing matter laterally comprises a generally horizontal translatable plunger body comprising a left side plunging surface and a right side plunging surface.

3. (canceled)

4. (canceled)

5. (canceled)

6. (canceled)

7. The apparatus of claim 2 further comprising a first hydraulically pivotally retractable containment barrier.

8. The apparatus of claim 7 further comprising a plurality of powered transfer rollers configured to propel logs through a debarking enclosure.

9. The apparatus of claim 8 further comprising first and second plunger cradles.

10. A selectable discharge direction mobile chain flail debarking apparatus configured to be primarily transported on a highway along a longitudinal axis of said mobile chain flail debarking apparatus which comprises:
a vehicle frame;
a debarking enclosure, operatively coupled to said vehicle frame and disposed around a flail section;
a plurality of rotating flail assemblies disposed within said debarking enclosure and being configured to remove bark from portions of logs;
an opening located below said flail section;
a debris collection area located below said opening;
first and second mounting frames being at least indirectly coupled said vehicle frame;
a generally horizontal translatable plunger body comprising a left side plunging surface and a right side plunging surface;
said plunger body being disposed below said opening, said plunger body configured to move from an open position on one side of said opening to a temporary plunging position; and
said plunger body being oriented and configured to translate in a first discharge direction, and said plunger body being oriented and configured to translate in a second and opposite discharge direction from said first discharge direction.

11. The apparatus of claim 10 further comprising first and second plunger cradles which are fixedly secured to the vehicle frame.

12. The apparatus of claim 11 further comprising: first and second mounting frames being secured to said first and second plunger cradles 136, respectively.

13. The apparatus of claim 12 wherein each of the first and the second plunger cradles 136 comprises an inverted C-shape recess 138 therein.

14. The apparatus of claim 13 wherein said first mounting frame is captively received within and movably guided by said inverted C-shaped recess of the first plunger cradle.

15. The apparatus of claim 14 wherein the second mounting frame is captively received within and movably guided by the inverted C-shaped recess of the second plunger cradle.

16. The apparatus of claim 15 further comprising a plurality of spaced apart rakes retractably coupled to said plunger body.

17. The apparatus of claim 16 wherein said plurality of spaced apart rakes are pivotally retractably coupled to said plunger body.

18. The apparatus of claim 17 further comprising a first hydraulically pivotally retractable containment barrier.

19. The apparatus of claim 18 further comprising a disc chipper.

20. The apparatus of claim 19 further comprising:
a. a debris transfer chute which facilitates discharge of debris generated by he disk chipper;
b. an inlet end of the debris transfer chute which is coupled to the disc chipper and arranged to collect the associated debris which is generated by the disk chipper during operation; and
c. an outlet end of the debris transfer chute is located to discharge the debris, generated by the disk chipper, into a debris collection area disposed below said plurality of rotating flail assemblies.
